(19) United States
(12) Patent Application Publication
(10) Pub. No.: US 2026/0216620 A1
(43) Pub. Date: Jul. 30, 2026

(54) RETENTION APPARATUS FOR MEMBRANE CHROMATOGRAPHY UNITS

(71) Applicant: CYTIVA BIOPROCESS R&D AB, Uppsala (SE)

(72) Inventors: Adam Pinnock, Stevenage (GB); Nirmal Kumar Thanikachalam, Stevenage (GB); Hannes Hjorter, Uppsala (SE); Shameer Subratty, Stevenage (GB); Gabriel Zenkner, Stevenage (GB)

(21) Appl. No.: 19/140,419

(22) PCT Filed: Dec. 14, 2023
(86) PCT No.: PCT/EP2023/085897

§ 371 Date: Jun. 18, 2025

(30) Foreign Application Priority Data
Dec. 19, 2022 (GB) 2219211.6

(51) Int. Cl. B01D 15/18; B01D 63/08

(52) U.S. Cl. CPC B01D 15/1896; B01D 63/0822; B01D 2313/02; B01D 2313/04; B01D 2313/2031; B01D 2313/24

(57) ABSTRACT

The present invention relates to a retention apparatus (100) for housing at least one membrane chromatography unit (110a), (110a′), (110b). The retention apparatus (100) may be suitable for use on a benchtop, and in various embodiments is relatively lightweight and may be manually lifted. The retention apparatus (100) comprises a retention housing (120) for retaining and aligning at least one membrane chromatography unit (110a), (110a′), (110b). The retention apparatus (100) also comprises a press mechanism (130) for applying pressure to the at least one membrane chromatography unit (110a), (110a′), (110b) when retained in the retention housing (120).

### TECHNICAL FIELD

The present invention relates generally to a retention apparatus for use with membrane chromatography units. For example, a press-based apparatus may be provided for aligning and ensuring a correct sealing configuration between one or more modular chromatography units that are provided therein in a serial fluidic arrangement.

### BACKGROUND

In many areas of medicine and biology there is a need to separate various biological and/or pharmaceutical components. For example, in bioprocessing applications there may be a need to separate various vaccine components (mRNA, DNA, etc.) or other protein-based targets (monoclonal antibodies, etc.) from other components derived as an output from a bioreactor.

One well-known way for separating such target components is to use a chromatography-based system and process. For example, various commercially available chromatography systems and products, such as the ÄKTA™ pure chromatography system, are available from Cytiva™ Life Sciences, of Uppsala, Sweden (see, for example, www.cytivalifesciences.com). Products available also include, for example, various Fibro™ PrismA protein A chromatography affinity units that can be used for rapid cycling chromatography in research and process development applications.

The use of modular chromatography units/modules to provide scalability is also known. For example, using an ÄKTA™ system or Sartorius™ cassettes provided in a holder (Sartobind™, Sartoflow™, Sartocube™, etc.).

Whilst the use of such systems, e.g. employing “stackable” single use tangential flow cassettes therein, allows the provision of scalable and reconfigurable systems for filtration, etc. improvements to such systems are still desired in the art. For example, systems that are easier to use and which may be operated at higher pressures/flow rates etc. are desirable.

Hence, the present invention is provided in order to address various shortcomings of prior art systems and devices.

### SUMMARY OF INVENTION

Various aspects and embodiments of the present invention, as defined by the appended claims, are thus provided.

For example, in a first aspect, the present invention provides a retention apparatus for housing at least one membrane chromatography unit. The retention apparatus may be suitable for use on a benchtop and comprises a retention housing for retaining and aligning at least one membrane chromatography unit and a press mechanism for applying pressure to the at least one membrane chromatography unit when retained in the retention housing.

By providing a retention apparatus in accordance with this aspect of the present invention, a strong compact retention housing can be provided that is easy to clean, quick to configure and which may operate at a high flow rate.

Moreover, certain embodiments of the present invention may also provide a lightweight retention housing that has improved portability, and ease of use, when it is to be used, for example, on a benchtop in clean/sterile environments to separate biological and/or pharmaceutical components.

### DRAWINGS

The present invention will now be described in more detail with reference to the appended drawings, in which:

FIG. 1 shows a benchtop retention apparatus including membrane chromatography units in accordance with an embodiment of the present invention;

FIG. 2 shows the benchtop retention apparatus of FIG. 1 without any membrane chromatography units therein in accordance with an embodiment of the present invention;

FIG. 3 shows an exploded view of the benchtop retention apparatus of FIG. 2;

FIG. 4 shows the benchtop retention apparatus of FIG. 1 with a casing component of a press mechanism removed therefrom;

FIG. 5 shows a cross sectional view through the benchtop retention apparatus of FIG. 1;

FIG. 6 shows a tie rod clamp assembly that may be used in the embodiments of a benchtop retention apparatus as shown in FIGS. 1 to 5; and

FIG. 7 shows a tie rod clamp assembly that may additionally, or alternatively, be used in the embodiments of a benchtop retention apparatus as shown in FIGS. 1 to 5.

### DETAILED DESCRIPTION

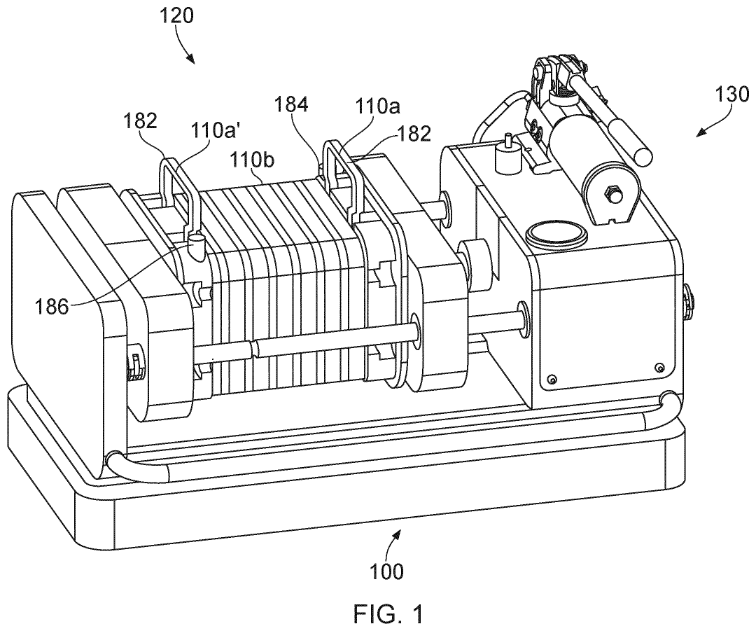

FIG. 1 shows a benchtop retention apparatus 100 including membrane chromatography units 110a, 110a′, 110b in accordance with an embodiment of the present invention. The retention apparatus 100 may optionally be constructed so as to be relatively light weight, thus making it suitable for use on a benchtop.

For example, various embodiments may be provided having a weight/mass without any membrane chromatography units therein of less than 100 kg, less than 70 kg, preferably less than 50 kg, more preferably less than 40 kg, e.g. about 35 to 38 kg, from about 5 or 10 kg to about 40 kg, or from about 15, 20, 30 or 34, 35 to about 35 kg or 38 kg. Additionally, various embodiments having a relatively compact size may also be provided. For example, having a size/volume footprint from about 500 to about 700 mm (length), from about 200 to about 500 mm (depth) and from about 300 to about 500 mm (height).

Various embodiments of the present invention are thus more readily usable than prior art devices/systems. For example, manual lifting/handling/manipulation (either mechanically aided—e.g. using pulleys/hoists/levers/guides etc.—or unaided) can be more easily facilitated either by a sole person/operator or more than one person as a team.

As shown in FIG. 1 a retention housing 120 is provided for retaining and aligning at least one membrane chromatography unit 110a, 110a′, 110b therein. In this embodiment, the membrane chromatography units 110a, 110a′, 110b take different forms depending upon whether they are end front/rear membrane chromatography units 110a, 110a′ or central membrane chromatography units 110b. The membrane chromatography units 110a, 110a′, 110b are preferably Fibro ReadyToProcess™ membrane chromatography units available from Cytiva™ Life Sciences, of Uppsala, Sweden.

Each of the front and rear membrane chromatography units 110a, 110a′ are provided with a respective handle 182. These may be provided as part of a pre-assembled cassette package provided with a pre-defined total internal volume. Such a pre-assembled cassette package may be operable at a relatively high flow rate (e.g. when subject to a pressure of about 8 to 10 bar, or to about 10 bar).

An inlet 184 is provided on an exterior portion of the front membrane chromatography unit 110a and an outlet 186 on an exterior portion of the rear membrane chromatography unit 110a′. Where any central membrane chromatography units 110b are provided, a fluidic channel exists between the inlet 184 and the outlet 186 that passes through both the end front/rear membrane chromatography units 110a, 110a′ and any such central membrane chromatography units 110b. In the absence of any central membrane chromatography units 110b being provided, a fluidic channel is provided between the inlet 184 and the outlet 186 that passes through both the front and rear membrane chromatography units 110a, 110a′ once they are pressed together in the retention housing 120.

A press mechanism 130 for applying pressure to the at least one membrane chromatography unit 110a, 110a′, 110b when retained in the retention housing 120 is also provided. The retention housing 120 is also designed to auto-align one or more membrane chromatography units 110a, 110a′, 110b so that fluid connection ports thereof match up and are sealed under pressure applied by the press mechanism 130.

In the embodiment of FIG. 1, the press mechanism 130 is hand-operable. However, this is not an essential requirement and various alternative press mechanisms may be used as required. Moreover, preferably, the press mechanism 130 can be operated to exert a force of up to about 25 kN (e.g. about 23 kN) upon any membrane chromatography units 110a, 110a′, 110b provided therein.

Various of the membrane chromatography units 110a, 110a′, 110b, or an assembled package thereof, may be provided. For example, volumes of 20 ml, 40 ml, 60 ml, . . . 120 ml, 140 ml, 160 ml, etc. may be used. Such membrane chromatography units 110a, 110a′, 110b, or an assembled package thereof, may operate at 0 bar-10 bar, for example. Use of high-pressure operation (e.g. at about 8 to 10 bar, or up to about 10 or more bar) can be used to provide faster flow-rates so as to increase overall process productivity.

Whilst FIG. 1 shows multiple forms of membrane chromatography unit therein, those skilled in the art would be aware that a retention apparatus in which all of the membrane chromatography units that are to be used therein are substantially identical could also be provided.

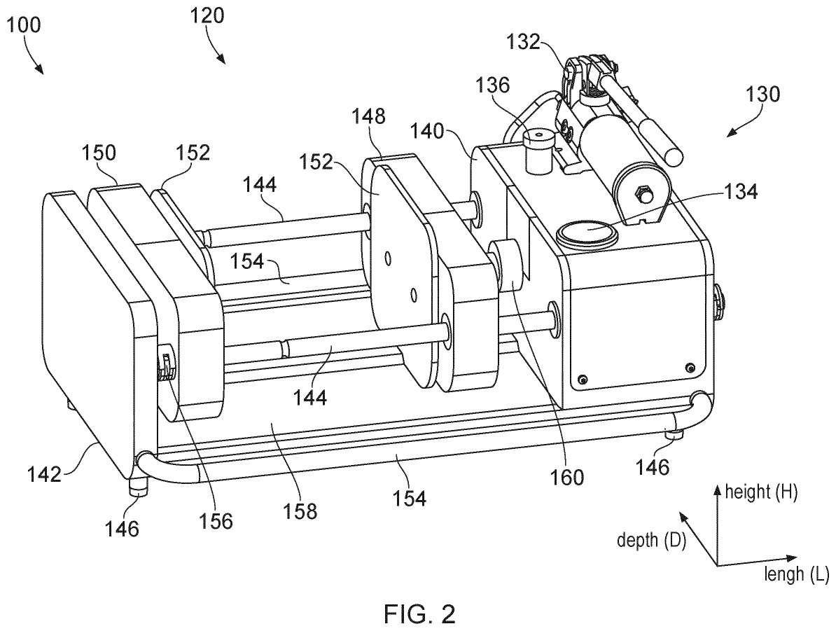

FIG. 2 shows the benchtop retention apparatus 100 of FIG. 1, without any membrane chromatography units therein, in accordance with an embodiment of the present invention. The retention apparatus 100 has a size/volume footprint of 688 mm (length L), 455 mm (depth D), and 388 mm (height H). Press mechanism 130 comprises a hydraulic unit 132, that in this embodiment includes a hand pump, a pressure gauge 134, and a shut off valve/check valve 136. The shut off valve/check valve 136 enables oil to flow therethrough in one direction until a desired pressure is reached using the press mechanism 130 (e.g. nominal 190 bar). The shut off valve/check valve 136 further prevents oil from flowing in a backwards direction until opened in order to retract the benchtop retention apparatus 100.

The press mechanism 130 is connected to the retention housing 120 in a frame front 140 thereof. The retention housing 120 also includes a frame rear 142 joined to the frame front 140 by way of a base tray 158 disposed therebetween. The base tray 158 may be provided to act as a spill tray and/or can be made from multiple sections, e.g. as a split base, for ease of manufacture. A first pair of feet 146 are provided on the base tray 158 with a second pair of feet 146 being provided on the frame front 140 for together supporting the retention apparatus 100 when in use.

The frame rear 142 and the frame front 140 are further connected by a pair of substantially parallel disposed handles 154 that extend generally parallel to a central axis of the retention apparatus 100 along the length axis (L). Such handles 154 permit the retention apparatus 100 to be manually lifted. Alternative embodiments may however be provided, for example, including one or more handle/attachment point/eyelet/etc., e.g. so as to assist with manual or manually activated lifting of the retention apparatus 100.

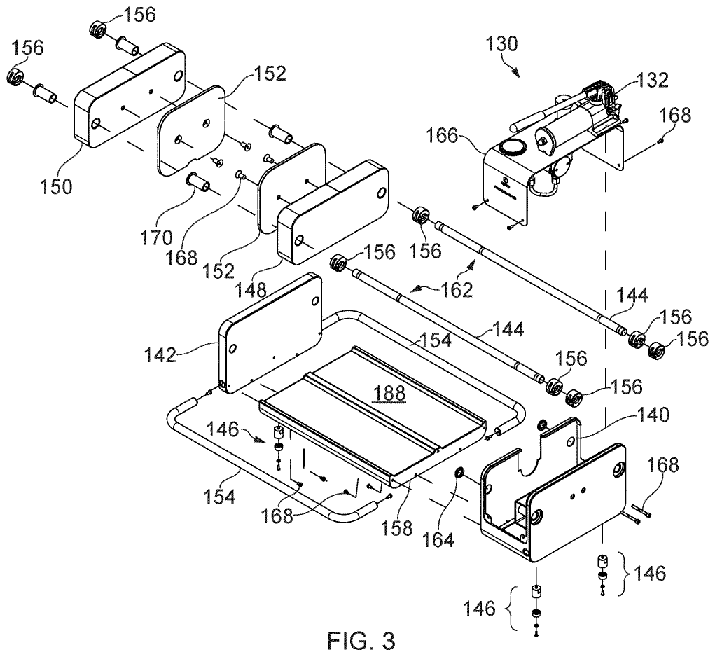

A pair of tie rods 144, that are disposed generally parallel to the central axis of the retention apparatus 100 along the length axis (L), are also provided. The tie rods 144 are maintained in a fixed relationship within the retention housing 120 between the frame rear 142 and the frame front 140 by way of a plurality of tie rod clamp assemblies 156, 256 (FIG. 3 shows this arrangement in more detail). The tie rods 144 support a rear force beam 150 adjacent to the frame rear 142 in a fixed relationship therebetween. The tie rods 144 also support a front force beam 148 adjacent to the frame front 140 in a moveable relationship therebetween. Both the rear force beam 150 and the front force beam 148 are provided with respective force plates 152 attached thereto that engage a respective membrane chromatography unit 110a, 110a′, 110b when inserted into the retention apparatus 100 as pressurised.

A piston connection actuator rod 160 couples the press mechanism 130 to the front force beam 148 through the front frame 140. Actuation of the press mechanism 130 thus causes the front force beam 148 to slidably translate along the tie rods 144, such that a force may be applied to any membrane chromatography units 110a, 110a′, 110b provided between the force plates 152.

FIG. 3 shows an exploded view of the benchtop retention apparatus 100 of FIG. 2. Frame front 140 is provided with a pair of feet 146, as is the base tray 158. The feet 146 may include respective base rubber feet, plain washers (e.g. Form A ISO 7089 4.3-A4), fasteners, etc. The press mechanism 130, comprising at least one casing component 166 (e.g. a panel which may be removable to enable full assessment, equipment specification, operation, verification of supporting safety information, etc.), fits into the frame front 140 and is retained therein by respective fasteners 168. In various embodiments, an interlock mechanism (not shown) may be provided such that operation of the press mechanism 130 is inhibited should any casing component 166 be absent or inadequately secured.

Frame front 140 and frame rear 142 connect to the base tray 158. Optionally, base tray 158 may act as a drip tray to capture hydraulic fluid should there be any leaks. Alternatively, or additionally, a separate drip tray (not shown) may be provided. Base tray 158 may be formed in multiple sections. A guide rail 188 is also present on the base tray 158. The guide rail 188 extends along the length axis L of the retention apparatus 100. The guide rail 188 is keyed in shape so as to cooperate with reciprocal notches provided in the membrane chromatography units 110a, 110a′, 110b. This enables the base tray 158 and guide rail 188, in cooperation with the force plates 152, to provide a frame that aligns the membrane chromatography units 110a, 110a′, 110b in a correct orientation when they are placed into the retention apparatus 100. In certain embodiments, the guide rail 188 or the like (e.g. a groove) may be asymmetrically shaped and/or located to further help prevent mis-insertion of membrane chromatography units 110a, 110a′, 110b in the retention apparatus 100.

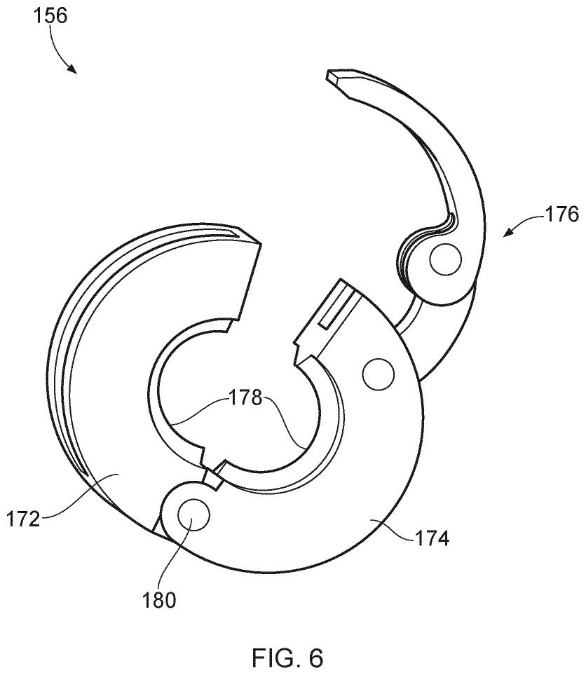

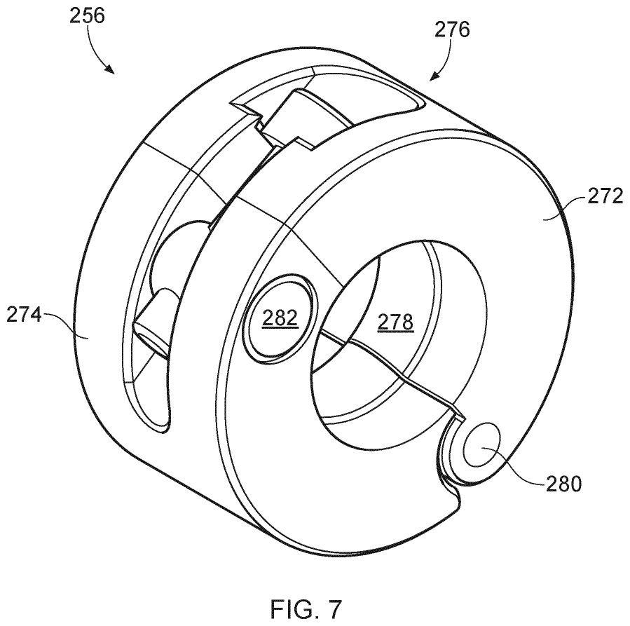

A pair of tie rods 144 are provided. The tie rods 144 each comprise four respective circumferential grooves 162 separated lengthwise from each other. These circumferential grooves 162 are each preferably semi-circular in cross-section, and are adapted to connect with a respective tie rod clamp assembly 156, 256 (see FIGS. 6 and 7). Two tie rod clamp assemblies 156, 256 connected to each tie rod 144 nearest to the press mechanism 132 are used to releasably secure the respective tie rod 144 to the frame front 140. A further two tie rod clamp assemblies 156, 256 are also releasably connectable to each tie rod 144 at positions proximal the frame rear 142. For each tie-rod 144 two tie rod clamp assemblies 156, 256 secure the tie-rod 144 into the retention apparatus 100 at the frame front 140 so as to prevent forward/backward movement of the tie rod 144. The central-most tie rod clamp assembly 156, 256 acts as a ‘transport clamp’ which constrains the front force beam 148 and the rear force beam 150 as the front force beam 148 is moved. The final tie rod clamp assembly 156, 256 proximal the rear force beam 150 is used to set the size of a compression zone by providing a ‘backstop’ for the force plates 152. The tie rod clamp assemblies 156, 256 can be operated in a quick-release fashion for ergonomics and security of fastening. Such an arrangement thus provides a retention apparatus 100 having a high-stiffness, high strength, skeleton that can be provided within a cosmetic exterior.

Various additional fixing components, fasteners 168, grommets 164 and bushes 170 used in the assembly of the retention apparatus 100 are also depicted in FIG. 3. Since the function of these is considered to be clear to the skilled person, they are not described further here, other than to say that they may include one or more of: a hex socket head cap screw, a hex socket flat CS head screw (e.g. M10X20-A4), a hex socket button head screw (e.g. M4X10-A2), a hex socket pan head screw (e.g. M5X8-A4-70), nuts, bolts, etc.

In this embodiment, the front force beam 148, the rear force beam 150, force plates 152 and the tie rods 144 are preferably made from a solid material. For example, steel (e.g. stainless steel, such as EN1.4404 stainless steel, EN1.4462 stainless steel, etc.) materials may be used for these (and other) components. In this instance, the tie rods 144 are made with a diameter of 19 mm, preferably from EN1.4462 stainless steel (compared to certain conventional presses that use 25 mm beams with substantially square cross-sectional notches therein) thus providing a substantial weight advantage.

In this embodiment, the retention apparatus 100 has a weight/mass of around 35 kg, as well as a size/volume footprint of 688 mm (length L), 455 mm (depth D), and 388 mm (height H), thus making it suitable for benchtop use. For example, a prototype of the retention apparatus 100 made had a total mass of about 37-38 kg, with 18 kg thereof comprising the load bearing elements (front force beam 148, rear force beam 150, force plates 152, tie rods 144 and tie rod clamp assemblies 156, 256), 8.5 kg comprising the press mechanism 130, and 11 kg the remaining parts.

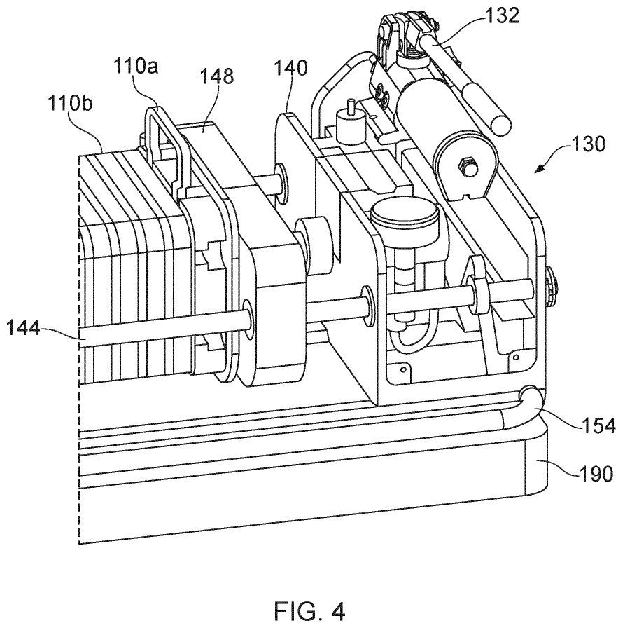

FIG. 4 shows the benchtop retention apparatus 100 of FIG. 1 with a casing component 166 of a press mechanism 130 removed therefrom. The press mechanism 130 may include an interlock mechanism that connects to the casing component 166, the absence of the casing component 166 then causing operation of the press mechanism 130 to be inhibited. As shown in FIG. 4, the benchtop retention apparatus 100 may be provided on a support trolley 190. Such a support trolley 190 is optionally provided as an accessory so as to enable the benchtop retention apparatus 100 to be more easily moved.

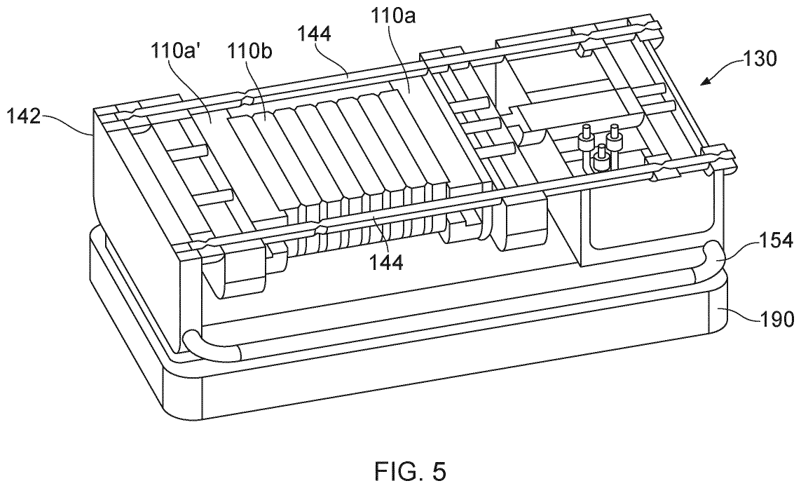

FIG. 5 shows a cross sectional view through the benchtop retention apparatus 100 of FIG. 1. As described above, the embodiment discussed herein is a relatively lightweight benchtop version of a retention apparatus 100. Nevertheless, those skilled in the art would realise that the present invention is not limited to only benchtop variants of a retention apparatus 100.

FIG. 6 shows a tie rod clamp assembly 156 used in embodiments of a retention apparatus, such as the benchtop retention apparatus 100 as shown in FIGS. 1 to 5. The tie rod clamp assembly 156 comprises a first tie rod clamp portion 172 and a second tie rod clamp portion 174. The first tie rod clamp portion 172 and the second tie rod clamp portion 174 are both substantially semi-annular in shape, and are joined together by a pivot attachment 180.

Each of the first tie rod clamp portion 172 and the second tie rod clamp portion 174 comprise a respective radially inward facing semi-annular tie rod engagement rim 178. The rim is preferably arcuate and hemicylindrical. The tie rod engagement rims 178 themselves are substantially semi-circular in cross-section. Provision of such semi-circular cross-section engagement rims 178 advantageously enables a greater force to be used by embodiments of the invention as compared to prior art systems (e.g. as it can reduce any induced localised stress build-up associated with angular shaped notches and the like).

A pivotable clasp mechanism 176 is attached to the second tie rod clamp portion 174 and is configured to engage the first tie rod clamp portion 172 when the first tie rod clamp portion 172 and the second tie rod clamp portion 174 are brought together in an annular arranged (closed) position.

Thus, when the tie rod clamp assembly 156 is in an open position (as shown in FIG. 6), the tie rod engagement rims 178 may be placed adjacent to a groove 162 of a tie rod 144. The first tie rod clamp portion 172 and the second tie rod clamp portion 174 may then be brought together into the annular arranged (closed) position, and clasp mechanism 176 may then be engaged to lock the tie rod clamp assembly 156 to the tie rod 144.

FIG. 7 shows a tie rod clamp assembly 256 that may additionally, or alternatively, be used in embodiments of a retention apparatus, such as the benchtop retention apparatus 100 as shown in FIGS. 1 to 5.

The tie rod clamp assembly 256 comprises a first tie rod clamp portion 272 and a second tie rod clamp portion 274. The first tie rod clamp portion 272 and the second tie rod clamp portion 274 are both substantially semi-annular in shape and are joined together by a first pivot attachment 280. Each of the first tie rod clamp portion 272 and the second tie rod clamp portion 274 comprise a respective radially inward facing semi-annular tie rod engagement rim 278. The rim is preferably arcuate and hemicylindrical in shape. The tie rod engagement rims 278 themselves are substantially semi-circular in cross-section. Such tie rod clamp assemblies can provide a greater surface contact area between components, such that they are able to tolerate higher pressures than conventional systems.

A pivotable clasp mechanism 276 is attached to the second tie rod clamp portion 274 by way of a second pivot attachment 282 and is configured to engage the first tie rod clamp portion 272 when the first tie rod clamp portion 272 and the second tie rod clamp portion 274 are brought together in an annular arranged (closed) position, as is shown. The pivotable clasp mechanism 276 comprises a substantially bolt-shaped component comprising a shaft portion connected to a head portion. The shaft portion is coupled to the second pivot attachment 282 proximal to an end thereof and the head portion is configured to reside in a recessed portion of the first tie rod clamp portion 272 when in the closed position.

In the present application, the terms “weight” and “mass” have been used interchangeably. Additionally, for the avoidance of doubt, the content of all or any previously mentioned documents, products, etc. are also hereby incorporated by reference in their entirety herein to the maximum permissible extent.

Various compact, relatively lightweight embodiments of the present invention may thus be provided. Improved ease of use, ease of cleaning, and suitability for use in clean/sterile environments can also or alternatively be provided. Such embodiments may further permit increased retaining forces to be applied using only a hand-operated pump. For example, as compared to conventional devices, a five to ten-fold increase in the retaining force that can be applied can be achieved. For example, various embodiments can provide a compressive force of ~20 kN (e.g. from about 20 kN to about 23 kN, or about 23 kN) to a compression zone that is retained for over 16 hours with a decompression of 5% or less. Such embodiments are also useful in a clean room environment and can be made resistant to cleaning compounds, such as, for example: chlorine compounds up to 0.5%, hydrogen peroxide, H₂O₂, up to 35%, Virkon 2%, Decon 90, 10%, etc.

Moreover, in various embodiment, a pre-assembled cassette package provided with a pre-defined total internal volume can be provided. Use of such pre-assembled cassette packages within retention apparatus of the present invention provides various advantages. For example, not only is set-up time reduced, but also no fluid manifolds/connectors etc. need be provided within components of the retention apparatus itself (i.e. by using various fluid path free components, unlike various of the prior art systems). Hence, various embodiments of the present invention can be made that are also easier to clean than certain prior art systems. Various inlets/outlets of a cassette package may also be configured to align with other related bioprocessing equipment (e.g. with the column positions of an ÄKTA ready™ chromatography system) for ease of connection/installation.

Additionally, various embodiments have an ergonomic design in which all the controls etc. are readily accessible. Guidance features for easily aligning the consumable membrane chromatography units/modules used therein can also preferably be provided to further aid ease of use.

Embodiments may also be provided in which one or more sensors are provided. For example, one or more sensors may also be provided for one or more of: detecting that at least one chromatography unit/module is present; providing indicator/alarm/lock functions if user tries to pressurise the apparatus without any module in it; provide for pressure under and/or over sensing; detecting correct motion of a press mechanism or parts connected to it, for example, so as to detect any foreign objects present and/or tie-bars that are kinked/damaged etc. An automated (or semi-automated) system can thus be provided in which a predetermined pressure/force can be applied within a target range, e.g. either as a fixed value, or based upon the number or type of modules used/detected.

Further embodiments are envisaged wherein parts thereof, such as tie rods etc., may be formed using at least one substantially hollow component therein to further reduce the weight/mass of the apparatus. Various embodiments of the present invention may thus provide a retention apparatus that has a force generation to weight ratio of: at least about 0.05, 0.07, 0.1, 0.2 or 0.25, 0.5, 0.7 or 1 kN/kg, from about 0.1 or about 0.25 kN/kg to about 0.3, 0.4 or about 0.5 kN/kg, or from about 0.1, 0.2 or 0.25 kN/kg to about 0.5 kN/kg, 0.7 kN/kg or about 1 kN/kg.

Additionally envisaged embodiments also include a retention apparatus comprising one or more wheels, skids or the like. These may be lockable/retractable/removable etc. in order to further facilitate moving the apparatus within a laboratory/production facility. For example, various “suitcase like” embodiments can be envisaged in which an apparatus is provided with one or more wheels at one end thereof with a handle being provided at an opposite end thereof.

Moreover, for example, whilst the embodiments herein described depict use of a hand operated pump, those skilled in the art would understand that alternative variants would be possible. For example, various embodiments may be provided having one or more electric, powered hydraulic etc. pump therein optionally provided with a control system that is operable to ensure that no over/under pressure occurs. Many other possible modifications would also be apparent to the skilled person.

Various aspects and embodiments of the present invention have thus been described. However, the invention is not to be seen as being limited by the embodiments described above, but can be varied within the scope of the appended claims as would be readily apparent to the person skilled in the art.

1. A retention apparatus (100) for housing at least one membrane chromatography unit (110a, 110a′, 110b), said retention apparatus (100) comprising:
a retention housing (120) for retaining and aligning at least one membrane chromatography unit (110a, 110a′, 110b); and
a press mechanism (130) for applying pressure to the at least one membrane chromatography unit (110a, 110a′, 110b) when retained in the retention housing (120).

2. The retention apparatus (100) of claim 1, wherein the retention housing (120) comprises a frame (152, 158, 188) for retaining and aligning said at least one membrane chromatography unit (110a, 110a′, 110b) in a serially-connected fluidic configuration.

3. The retention apparatus (100) of claim 1 or 2, further comprising at least one movable force beam (148) for compressing said at least one membrane chromatography unit (110a, 110a′, 110b).

4. The retention apparatus (100) of claim 3, wherein said at least one movable force beam (148) is slidably mounted on at least one tie rod (144).

5. The retention apparatus (100) of claim 4, wherein each respective tie rod (144) is retained within said retention housing (120) by at least one tie rod clamp assembly (156, 256).

6. The retention apparatus (100) of any preceding claim, further comprising a rear force beam (150).

7. The retention apparatus (100) of any of claims 3 to 6, wherein said at least one movable force beam (148) and/or said rear force beam (150) is/are fluid path free.

8. The retention apparatus (100) of claim 7, wherein said at least one movable force beam (148) and/or said rear force beam (150) is/are formed of a solid material.

9. The retention apparatus (100) of any preceding claim, further comprising one or more casing component (166) therein, and optionally wherein at least one said casing component (166) comprises an interlock mechanism.

10. The retention apparatus (100) of any preceding claim, having a weight/mass without any membrane chromatography units (110a, 110a′, 110b) therein of less than 100 kg, less than 70 kg, preferably less than 50 kg, more preferably less than 40 kg, e.g. from about 5 or 10 kg to about 40 kg, or from about 15 to about 35 kg.

11. The retention apparatus (100) of claim 10, wherein a/the frame (152, 158) part thereof has a weight/mass of less than 70 kg, such as from about 15 to about 25 kg.

12. The retention apparatus (100) of any preceding claim, having a size/volume footprint from about 500 to about 700 mm (length), from about 200 to about 500 mm (depth) and from about 300 to about 500 mm (height).

13. The retention apparatus (100) of claim 12, wherein the size/volume footprint is about 700 mm (length), about 400 mm (depth), and about 400 mm (height).

14. The retention apparatus (100) of any preceding claim, wherein the press mechanism (130) is operable to: i) exert a force of up to about 25 kN; and/or ii) to pressurise at least one membrane chromatography unit (110a, 110a′, 110b) therein to a pressure of greater than about 2, 3, 4, 5, 6, 7, 8, 9, 10, 11 or 12 bar, from about 2, 3, 4, 5, 6 or 7 bar to about 8, 9, 10, 11 or 12 bar, from about 8 to 10 bar, or up to about 10 bar.

15. The retention apparatus (100) of any preceding claim, wherein the press mechanism (130) is hand-operable.

16. The retention apparatus (100) of any preceding claim, further comprising at least one handle (154), attachment point, eyelet, or the like.

17. The retention apparatus (100) of any preceding claim, further comprising one or more wheels, skids or the like.

18. A tie rod clamp assembly (156, 256) for use in the retention apparatus (100) of any preceding claim, comprising:
a first tie rod clamp portion (172, 272) rotatably coupled to a second tie rod clamp portion (174, 274); and
at least one pivotable clasp mechanism (176, 276) for inhibiting rotational movement of the first tie rod clamp portion (172, 272) with respect to the second tie rod clamp portion (174, 274) about a first pivot attachment (180, 280).

19. The tie rod clamp assembly (156, 256) of claim 18, wherein the first tie rod clamp portion (172, 272) and the second tie rod clamp portion (174, 274) comprise respective tie rod engagement rims (178, 278).

20. The tie rod clamp assembly (156, 256) of claim 19, wherein the tie rod engagement rims (178, 278) are substantially semi-circular in cross-section and/or substantially arcuate and hemicylindrical in shape.

21. The tie rod clamp assembly (256) of any claims 18 to 20, wherein the pivotable clasp mechanism (276) comprises a substantially bolt-shaped or T-shaped component comprising a shaft portion connected to a head portion.

22. The tie rod clamp assembly (256) of claim 21, wherein the shaft portion is coupled to a second pivot attachment (282) proximal to an end thereof and the head portion is configured to reside in a recessed portion of the first tie rod clamp portion (272) when in a closed position

23. A chromatography unit (110a, 110a′, 110b) for use in the retention apparatus (100) of any of claims 1 to 17, said chromatography unit (110a, 110a′, 110b) comprising at least one keyed feature, such as a notch or protrusion, in a casing thereof for keyed engagement with a guide rail (188) or other reciprocal keyed feature of the retention apparatus (100).

24. The chromatography unit (110a, 110a′, 110b) of claim 23, wherein the chromatography unit (110a, 110a′, 110b) comprises at least one handle (182), is a single use product, is provided pre-sterilised (e.g. by gamma radiation), is stackable and/or is provided with one or more with quick-remove seals/coverings (e.g. film-based covers) at fluid ports thereof.

25. A pre-assembled cassette package comprising a plurality of chromatography units (110a, 110a′, 110b) as defined in claim 23 or 24, wherein a first chromatography unit (110a) and a second chromatography unit (110a′) thereof comprise respective of a fluid inlet port and a fluid outlet port.

26. The pre-assembled cassette package of claim 25, wherein the first chromatography unit (110a) and the second chromatography unit (110a′) are provided with respective handles (182).

27. A method for separating biological components from a fluid mixture, comprising:
i) providing a retention apparatus (100) as defined by any of claims 1 to 17;
ii) installing at least one chromatography unit (110a, 110a′, 110b) in the retention apparatus (100);
iii) pressurising the at least one chromatography unit (110a, 110a′, 110b); and
iv) using said pressurised at least one chromatography unit (110a, 110a′, 110b) to separate biological components from a fluid mixture.

28. The method of claim 27, further comprising, prior to step ii), placing the retention apparatus (100) on a worktop or benchtop.

29. The method of claim 27 or 28, wherein the step ii) of installing at least one chromatography unit (110a, 110a′, 110b) in the retention apparatus (100) comprises installing a pre-assembled cassette package of a predetermined internal volume in the retention apparatus (100).

30. The method of any of claims 27 to 29, wherein the step iii) of pressurising the at least one chromatography unit (110a, 110a′, 110b) comprises pressurising said at least one chromatography unit (110a, 110a′, 110b) to a pressure of greater than about 2, 3, 4, 5, 6, 7, 8, 9, 10, 11 or 12 bar, from about 2, 3, 4, 5, 6 or 7 bar to about 8, 9, 10, 11 or 12 bar, from about 8 to 10 bar, or up to about 10 bar.
